(19) United States
(12) Patent Application Publication
(10) Pub. No.: US 2026/0017262 A1
(43) Pub. Date: Jan. 15, 2026

(54) TABLE SEMIJOIN DYNAMIC PRUNING

(71) Applicant: SAP SE, Walldorf (DE)

(72) Inventors: Manuel Mayr, Walldorf (DE); Paul Willems, Heidelberg (DE)

(21) Appl. No.: 18/767,012

(22) Filed: Jul. 9, 2024

(51) Int. Cl. G06F 16/2453

(52) U.S. Cl. CPC G06F 16/24544; G06F 16/24537

(57) ABSTRACT

A query execution plan is generated for a received query. The query execution plan may include a first operator with a predicate tree. The predicate tree may be expanded into one or more predicates and a value list, where the value list being empty satisfies a pruning condition. In response to determining that the pruning condition is satisfied, the first operator is pruned from the query execution plan. The value list may include a list of values specified by an expression associated with a first table and a column index of a second table. After pruning the first operator from the query execution plan, a pruned version of the query execution plan that does not include the first operator is executed.

### TECHNICAL FIELD

The present disclosure generally relates to pruning operators based on the operators having empty value identifier (ID) lists.

### BACKGROUND

Database management systems have become an integral part of many computer systems. For example, some systems handle hundreds if not thousands of transactions per second. On the other hand, some systems perform very complex multidimensional analysis on data. In both cases, the underlying database may need to handle responses to queries very quickly in order to satisfy systems requirements with respect to transaction time. A database query is a mechanism for retrieving data from one or more database tables. Queries may be generated in accordance with a corresponding query language. For example, structured query language (SQL) is a declarative querying language that is used to retrieve data from a relational database. Given the complexity of queries and/or the volume of queries, the underlying databases face challenges when attempting to optimize performance.

### SUMMARY

In some implementations, a query execution plan is generated for a received query. The query execution plan may include a first operator with a predicate tree. The predicate tree may be expanded into one or more predicates and a value list, where the value list being empty satisfies a pruning condition. In response to determining that the pruning condition is satisfied, the first operator is pruned from the query execution plan. The value list may include a list of values specified by an expression associated with a first table and a column index of a second table. After pruning the first operator from the query execution plan, a pruned version of the query execution plan that does not include the first operator is executed.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a diagram of an example of a computing system, in accordance with some example implementations of the current subject matter;

FIG. 2 illustrates a diagram of a HashJoin query plan fragment, in accordance with some example implementations of the current subject matter;

FIG. 3 illustrates a diagram of an optimized query plan fragment, in accordance with some example implementations of the current subject matter;

FIG. 4 illustrates a diagram of execution pipelines for executing a query execution plan, in accordance with some example implementations of the current subject matter;

FIG. 5 illustrates a pseudocode example for detecting if a pruning condition is satisfied, in accordance with some example implementations of the current subject matter;

FIG. 6 illustrates a process for pruning operators of a query execution plan, in accordance with some example implementations of the current subject matter;

FIG. 7 illustrates a process for pruning operators of a query execution plan, in accordance with some example implementations of the current subject matter;

FIG. 8 illustrates a process for operating a pruning inference engine, in accordance with some example implementations of the current subject matter;

FIG. 9A depicts an example of a system, in accordance with some example implementations of the current subject matter; and

FIG. 9B depicts another example of a system, in accordance with some example implementations of the current subject matter.

### DETAILED DESCRIPTION

SemiJoin Reduction is an optimization technique that aims at reducing so called dangling tuples from the probe side that would never produce a match in a HashJoin. For example, an optimizer may rewrite a HashJoin into a plan that leverages SemiJoin Reduction via a TableScanSemiJoin. When implementing SemiJoin Reduction, a dynamic in-list may be assembled during runtime. As used herein, the term “in-list” may be defined as a bit vector that is used to encode dictionary-encoded values that are part of the list.

Similar to a user-specified in-list, the dynamic in-list is injected into the predicate tree of a slightly adjusted TableScan, called a TableScanSemiJoin, and evaluated along with the remaining predicates. The ValueList represents the dynamic in-list, which may be assembled during runtime. As used herein, the term “value list” (or “ValueList”) may be defined as values from a first table which are filtered based on a column from a second table. In an example, ValueList(S.exp, T.col) signifies that the values from S.exp must be collected from the in-list that is evaluated on column T.col. S.exp and T.col are the expressions that form the join predicate.

In a query plan where a TableScanSemiJoin is employed, one aim is to reduce the tuples from the probe side (i.e., from table T). For this reason, a shared subplan may be introduced which sends the data chunks stemming from table S along the build side and towards the TableScanSemiJoin. The TableScanSemiJoin collects the build-expression and assembles an InList that is eventually used to evaluate the ValueList, similar to an in-list T.col in (s1, . . . , sN), where s1, . . . , sN are distinct elements of S.exp.

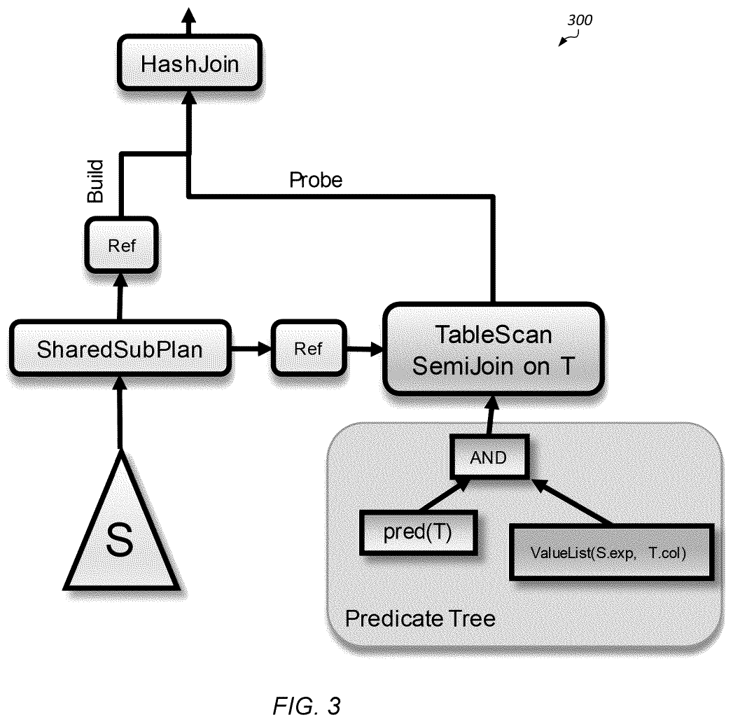

If the in-list T.col is empty, evaluation of the TableScanSemiJoin may be omitted, along with the subsequent HashJoin that is part of the same evaluation strand. This is possible because the ValueIDList and pred(T) are connected by a conjunction, as shown in the optimized query plan fragment 300 of FIG. 3. This means that if the ValueIDList does not deliver any result (i.e., the in-list is empty), the final result also does not deliver any result, without considering and evaluating pred(T). Consequently, this also means that the TableScanSemiJoin does not produce any result and can hence be pruned. Furthermore, other operators may also be pruned based on the fact that the TableScanSemiJoin does not produce a result.

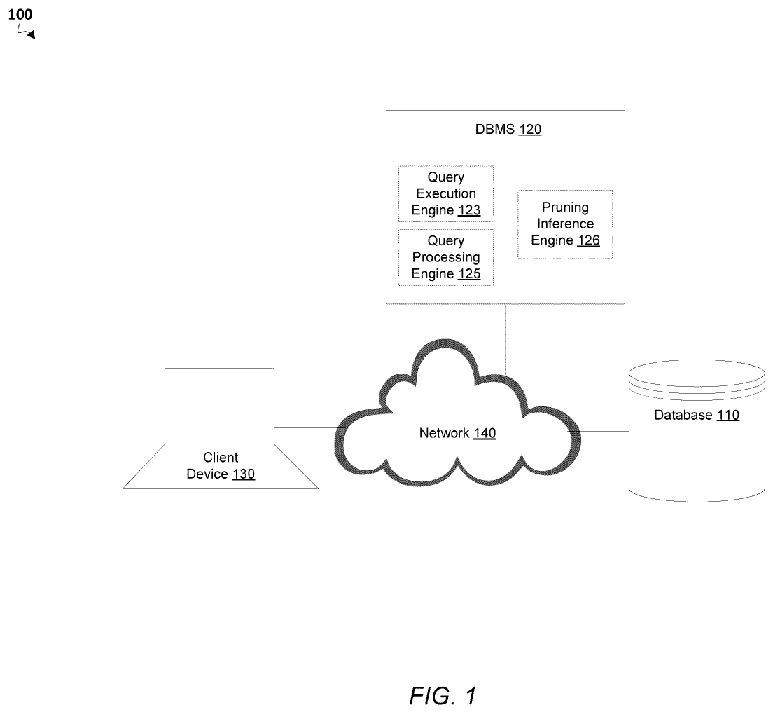

FIG. 1 depicts an example of a computing system 100, in accordance with some example embodiments. Referring to FIG. 1, the computing system 100 may include a database 110, a database management system (DBMS) 120, and a client device 130. In an example, database management system 120 includes at least query execution engine 123, query processing engine 125, and pruning inference engine 126. In other examples, database management system 120 may include other types of components. It is noted that database management system 120 may also be referred to as a database execution engine. It is also noted that while only a single database 110, a single database management system 120, and a single client device 130 are shown in FIG. 1, this is merely to avoid cluttering the figure. It should be appreciated that database 110 is representative of any number of databases, database management system 120 is representative of any number of database management systems, and client device 130 is representative of any number of client devices that may be included as part of computing system 100.

From an application or client perspective, it can be extremely cumbersome to access databases such as database 110. For example, an application may need to query different types of databases using complex queries. As a consequence, the application layer would need to be configured to handle the various types of databases and the various query types. Additionally or alternatively, each database 110 may need to process queries from the application into a format and structure that can be handled by the given database. Pushing complex operations and support for a variety of different database types to the application layer may contravene the need to have relatively lighter weight and/or readily deployable applications. On the other hand, pushing complex operations to the database layer where data is stored may draw processing and/or memory resources at the database 110 and may thus reduce the performance and response times for queries on that database layer.

In some example implementations, query execution engine 123 and/or query processing engine 125 may decouple the higher-level, application layer from the database layer (e.g., the persistence or storage layer where data including database tables may be stored and/or queried using instructions, such as commands and/or the like). The query execution engine 123 and/or query processing engine 125 may be implemented separately from the database layer and/or the application layer. Further, the query execution engine 123 and/or query processing engine 125 may be configured to receive a query, generate a query plan (including for example query algebra), optimize the query plan, and/or generate executable code, which can be executed at runtime. The executable code may include pre-compiled code (which can be selected for certain operations in the query plan) and/or code that is generated just-in-time specifically for execution of the query plan.

After query execution engine 123 and/or query processing engine 125 generate a query execution plan, pruning inference engine 126 may be configured to determine whether various operators in the query execution plan may be pruned based on the presence of empty ValueLists in the query plan. In an example, the query execution plan may be structured as a directed acyclic graph. In some embodiments, pruning inference engine 126 may traverse an operator topology of the query execution plan to identify potential operators that are candidates for pruning. As used herein, the term “operator” may be defined as an object of a class, where the object has a run method which implements the run-time semantics of the operator. The body of the run method is a sequence of execution steps.

In an example, a dynamic in-list may be assembled during runtime. The dynamic in-list may be injected into the predicate tree of a TableScanSemiJoin, and the dynamic in-list may be evaluated along with the remaining predicates. If pruning inference engine 126 determines that the dynamic in-list T.col is empty, evaluating the TableScanSemiJoin may be skipped, along with the subsequent HashJoin that is part of the same evaluation strand. This is possible because if the ValueIDList does not deliver any result (i.e., the in-list is empty), the final result also does not deliver any result, without considering and evaluating other predicates in the predicate tree. Consequently, this also means that the TableScanSemiJoin does not produce any result and can hence be pruned. Furthermore, other operators may also be pruned based on the fact that the TableScanSemiJoin does not produce a result. When an operator is pruned, this means that the operator will not be executed as part of the query execution plan. In other words, a pruned operator is removed from the query execution plan.

It is noted that pruning inference engine 126 may perform the above steps on the query execution plan or on a fragment (i.e., a portion) of the query execution plan. After pruning inference engine 126 determines whether one or more dynamic in-lists are empty and prunes corresponding operators from the query execution plan, the query execution engine 123 and/or query processing engine 125 may execute an updated version of the query execution plan.

The database 110, the database management system 120, and the client device 130 may be communicatively coupled via a network 140. In some example embodiments, the database 110 may be a relational database. However, it should be appreciated that the database 110 may be any type of database including, for example, an in-memory database, a hierarchical database, an object database, an object-relational database, and/or the like. For example, instead of and/or in addition to being a relational database, the database 110 may be a graph database, a column store, a key-value store, a document store, and/or the like.

The database management system 120 may be configured to respond to requests from one or more client devices including, for example, the client device 130. For example, as shown in FIG. 1, the client device 130 may communicate with the database management system 120 via the network 140, which may be any wired and/or wireless network including, for example, a public land mobile network (PLMN), a wide area network (WAN), a local area network (LAN), a virtual local area network (VLAN), the Internet, and/or the like. The client device 130 may be a processor-based device including, for example, a desktop computer, a laptop, a smartphone, a tablet computer, a wearable apparatus, a virtual assistant, an Internet-of-Things (IoT) appliance, and/or the like.

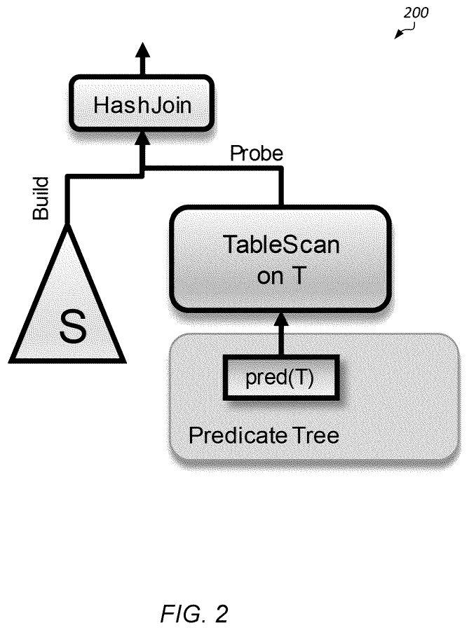

Turning now to FIG. 2, a diagram of a HashJoin query plan fragment is depicted, in accordance with one or more embodiments of the current subject matter. In the diagram shown in FIG. 2, a plan fragment of a HashJoin is depicted. This query plan fragment illustrates the query plan prior to the query plan being optimized. As depicted in FIG. 2, the build side of the HashJoin is on the left side of the plan fragment, while the probe side is located on the right side of the plan fragment. The build side of the HashJoin is constructed from a table S, and the probe side of the HashJoin performs a TableScan on table T based on a predicate tree. The predicate tree is representative of any number and type of predicates that may be defined for table T.

In an example, query plan fragment 200 may be optimized to generate optimized query plan fragment 300, as shown in FIG. 3. Specifically, the optimized query plan fragment 300 is intended to represent the original query plan fragment 200 (of FIG. 2) after an optimization step has been performed. The optimizations that have transformed original query plan fragment 200 into optimized query plan fragment 300 include the introduction of a shared subplan on the build side of the HashJoin. The tuples that are pushed from the subplan are sent to both the build side and the probe side. The introduction of the TableScan SemiJoin operator is another optimization of optimized query plan fragment 300 as compared to original query plan fragment 200. SemiJoin Reduction is an optimization technique that aims at reducing so called dangling tuples from the probe side, with dangling tuples including those tuples that would not produce a match in a HashJoin. Additionally, the generation of a ValueList and the AND conjunction within the predicate tree are further optimizations of optimized query plan fragment 300. The ValueList is used to filter the elements based on the build expression.

In an example, a dynamic in-list may be assembled during runtime. Similar to a user-specified in-list, the dynamic in-list may be injected into the predicate tree of the TableScan SemiJoin operator. The dynamic in-list may be evaluated along with the remaining predicates. The ValueList depicted in optimized query plan fragment 300 represents the dynamic in-list. In the illustrated example, ValueList(S.exp, T.col) signifies that the values from S.exp are collected for evaluation on column T.col. S.exp and T.col are the expressions that form the join predicate.

If the in-list T.col is empty, then the evaluation of the TableScan SemiJoin may be eliminated from the query execution plan. Additionally, the subsequent HashJoin may also be eliminated from the query execution plan if the in-list T.col is empty. This is possible because the ValueIDList and pred(T) are connected by a conjunction. This means that if the ValueIDList does not deliver any result, the final result also does not deliver any result, without having to consider and evaluate pred(T). Consequently, this also means that the TableScan SemiJoin operator does not produce any result and therefore, the TableScan SemiJoin operator may be pruned. Furthermore, other operators may also be pruned based on the fact that the TableScan SemiJoin operator does not produce a result.

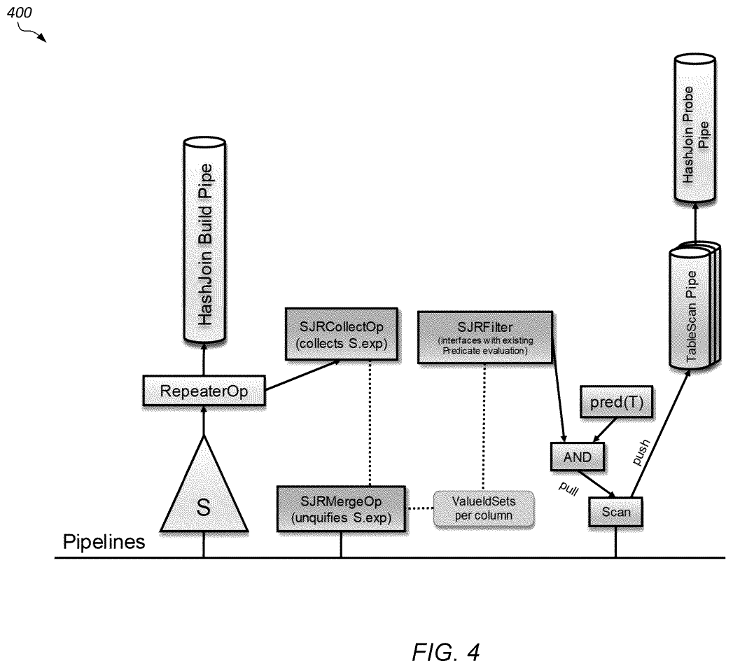

Turning now to FIG. 4, a diagram of execution pipelines for executing a query execution plan is shown, in accordance with one or more embodiments of the current subject matter. The discussion of FIG. 4 is intended to be a continuation of the discussion of FIG. 3. Accordingly, pipeline representation 400 is representative of the transformation of optimized query plan fragment 300 into a runtime executable format. In other words, the physical algebra of optimized query plan fragment 300 may be transformed into pipeline representation 400 in preparation for runtime execution of a corresponding query execution plan.

On the left side of FIG. 4 is the build pipe while the probe pipe is on the right-side of FIG. 4. A state reference is produced which is a ValueSet per column, which are the values that are collected from the build side. Also, a column index is collected which references the column. Then, a merge operator is defined after which a pruning rule can be evaluated to determine if the ValueSet is empty.

In an example, a pruning inference engine (e.g., pruning inference engine 126 of FIG. 1) delivers the following information: First, a stateRef to the “ValueSets per column” state that serves as a reducer. In the build pipe, a collector operator collects the values for S.exp. Second, a column index that identifies the position within the “ValueSets per column” state. Third, a merge operator which uniquifies S.exp to remove duplicates after which a pruning specification can be evaluated. If any of the ValueSets are empty, the scan operator may be pruned, which may result in a cascade of operator prunings.

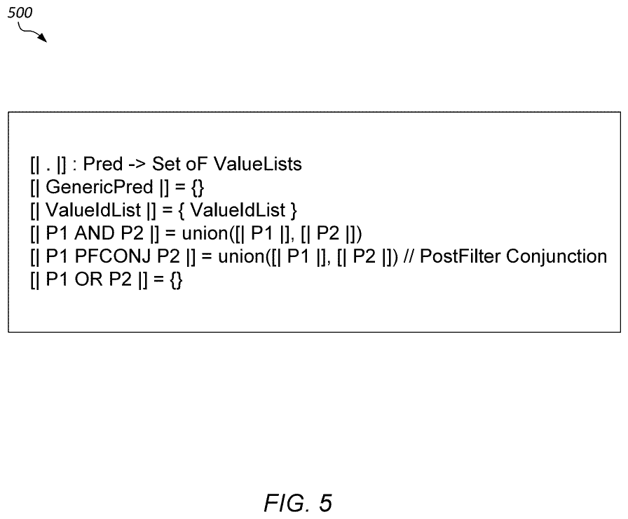

Referring now to FIG. 5, an example of pseudocode 500 for detecting if a pruning condition is satisfied is shown, in accordance with one or more embodiments of the current subject matter. In an example, pruning inference may be implemented as a function from a predicate to a set of value IDs. Accordingly, if one value ID set is empty, the entire predicate is empty (i.e., the predicate results in empty tuples). There is a determination for each generic predicate (i.e., GenericPred) if the result of the generic predicate is an empty set. Each eligible value ID list is evaluated at runtime. If there is a conjunction of predicates P1 and P2, then a union is recursively called on P1 and P2. Predicates may be differentiated into pre-filter predicates and post-filter predicates. If there is a post-filter conjunction, then a union is recursively called on P1 and P2. For a disjunction (i.e., P1 OR P2), the empty set is returned. Based on the resulting Value Lists, the pruning information may be extracting from the partition information map for each Value List. The pruning information may be calculated and applied on a per partition basis.

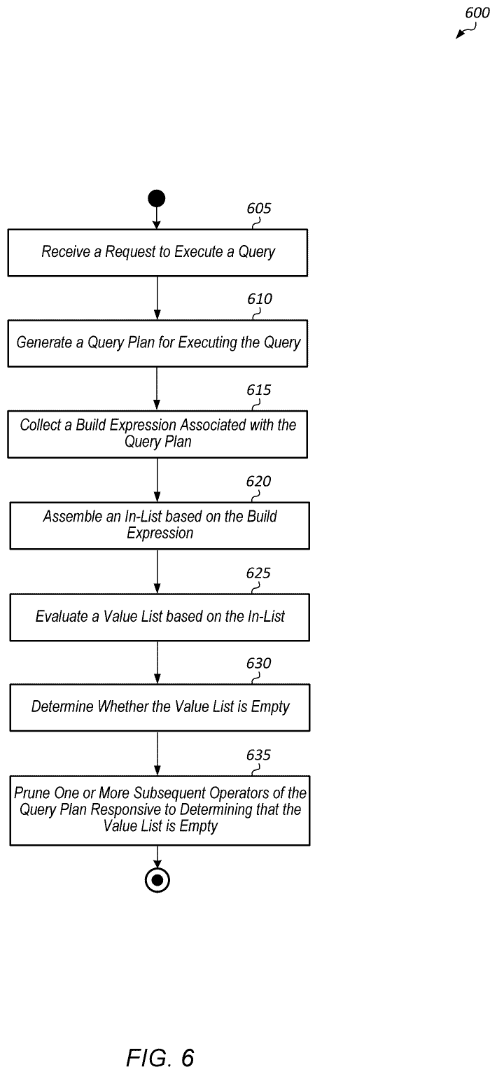

Turning now to FIG. 6, a process for pruning operators of a query execution plan is depicted, in accordance with one or more embodiments of the current subject matter. A request to execute a query is received by a database management system (block 605). Next, a query plan is generated for executing the query (block 610). Then, a build expression associated with the query plan is collected (block 615). In an example, the build expression may be associated with the build side of a HashJoin. In other examples, the build expression may be associated with other types of operators. Next, an in-list is assembled based on the build expression (block 620). In an example, the in-list may be assembled based on an expression associated with first data from a first table and a reference to a column associated with second data from a second table. Then, a value list is evaluated based on the in-list (block 625). In an example, the value list is generated at runtime. The value list may include the actual runtime values of the assembled in-list. Next, the database management system determines whether the value list is empty (block 630). Then, the database management system prunes one or more subsequent operators of the query plan responsive to determining that the value list is empty (block 635). After block 635, method 600 ends.

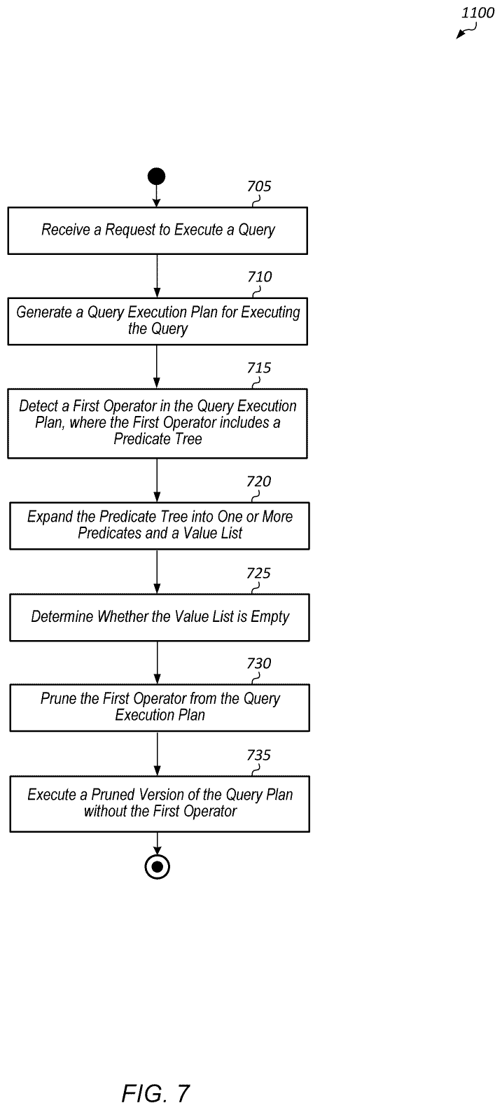

Referring now to FIG. 7, a process for pruning operators of a query execution plan is depicted, in accordance with one or more embodiments of the current subject matter. A request to execute a query is received by a database management system (block 705). In response to receiving the request to execute the query, the database management system generates a query execution plan to execute the query (block 710). Next, the database management system detects a first operator in the query execution plan, where the first operator includes a predicate tree (block 715). In an example, the first operator is a TableScan Semi Join operator. In other examples, the first operator may be any of various other types of operators.

Then, the database management system expands the predicate tree into one or more predicates and a ValueList (block 720). Next, the database management system determines whether the ValueList is empty (block 725). Responsive to determining that the ValueList is empty, the database management system prunes the first operator from the query execution plan (block 730). Next, the database management system executes a pruned version of the query execution plan without the first operator (block 735). It is noted that the database management system may prune one or more subsequent operators from the query execution plan in addition to the first operator. In these cases, the pruned version of the query execution plan may omit these one or more subsequent operators. After block 735, method 700 may end.

It is noted that the database management system may perform blocks 715-730 for each operator with a predicate tree in the query execution plan. It is also noted that any suitable component of the database management system may perform the steps of method 700. In an example, a query execution engine may perform the steps of method 700. In other examples, the query execution engine (e.g., query execution engine 123) may perform one or more of the steps of method 700 while other components (e.g., pruning inference engine 126) perform one or more other steps of method 700.

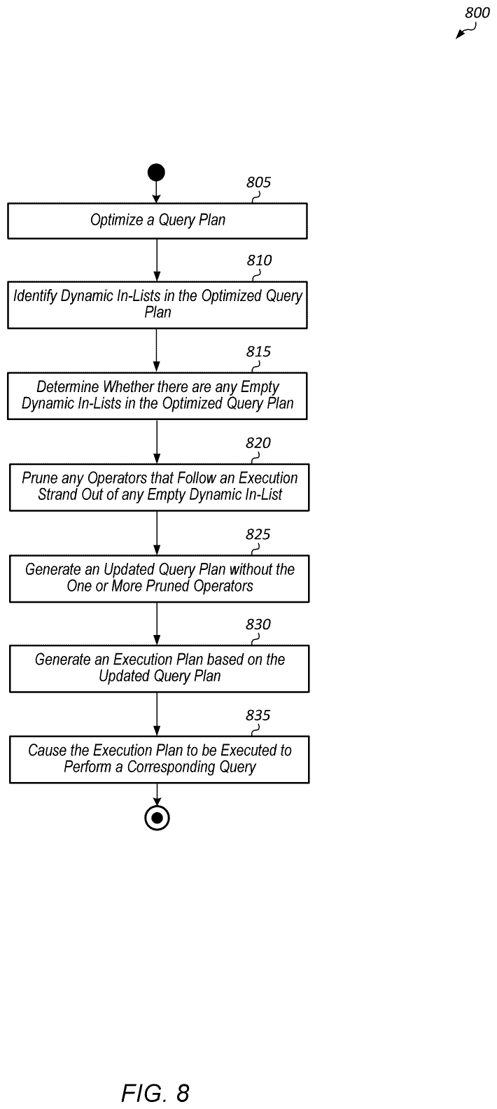

Turning now to FIG. 8, a process for operating a pruning inference engine is depicted, in accordance with one or more embodiments of the current subject matter. A query plan is optimized (block 805). A pruning inference engine identifies dynamic in-lists in the optimized query plan (block 810). A pruning inference engine determines whether there are any empty dynamic in-lists in the optimized query plan (block 815). The pruning inference engine prunes any operators that follow an execution strand out of any empty dynamic in-list (block 820). A query optimizer generates an updated plan without the one or more pruned operators (block 825). Next, a query processing engine generates an execution plan based on the updated query plan (block 830). Then, a database management system causes the execution plan to be executed to perform a corresponding query (block 835). After block 835, method 800 may end.

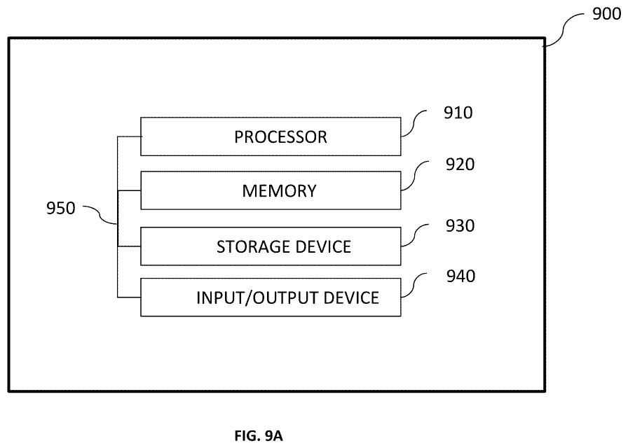

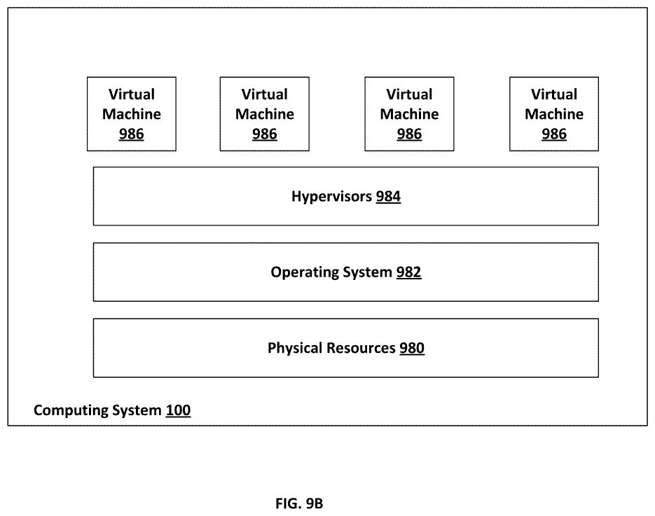

In some implementations, the current subject matter may be configured to be implemented in a system 900, as shown in FIG. 9A. The system 900 may include a processor 910, a memory 920, a storage device 930, and an input/output device 940. Each of the components 910, 920, 930 and 940 may be interconnected using a system bus 950. The processor 910 may be configured to process instructions for execution within the system 900. In some implementations, the processor 910 may be a single-threaded processor. In alternate implementations, the processor 910 may be a multi-threaded processor. The processor 910 may be further configured to process instructions stored in the memory 920 or on the storage device 930, including receiving or sending information through the input/output device 940. The memory 920 may store information within the system 900. In some implementations, the memory 920 may be a computer-readable medium. In alternate implementations, the memory 920 may be a volatile memory unit. In yet some implementations, the memory 920 may be a non-volatile memory unit. The storage device 930 may be capable of providing mass storage for the system 900. In some implementations, the storage device 930 may be a computer-readable medium. In alternate implementations, the storage device 930 may be a floppy disk device, a hard disk device, an optical disk device, a tape device, non-volatile solid state memory, or any other type of storage device. The input/output device 940 may be configured to provide input/output operations for the system 900. In some implementations, the input/output device 940 may include a keyboard and/or pointing device. In alternate implementations, the input/output device 940 may include a display unit for displaying graphical user interfaces.

FIG. 9B depicts an example implementation of the computing system 100 (of FIG. 1). The computing system 100 may be implemented using various physical resources 980, such as at least one or more hardware servers, at least one storage, at least one memory, at least one network interface, and the like. The computing system 100 may also be implemented using infrastructure, as noted above, which may include at least one operating system 982 for the physical resources 980 and at least one hypervisor 984 (which may create and run at least one virtual machine 986). For example, each multitenant application may be run on a corresponding virtual machine 986.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method comprising: generating a query execution plan for a received query; detecting a first operator with a predicate tree in the query execution plan; responsive to determining that a pruning condition is satisfied, pruning the first operator from the query execution plan; and executing a pruned version of the query execution plan that does not include the first operator.

Example 2: The computer-implemented method of Example 1, further comprising expanding the predicate tree into one or more predicates and a value list, wherein the value list being empty satisfies the pruning condition.

Example 3: The computer-implemented method of any of Examples 1-2, wherein the value list comprises a list of values specified by an expression associated with a first table and a column index of a second table.

Example 4: The computer-implemented method of any of Examples 1-3, further comprising: receiving a request to execute a query; collecting a build expression associated with the receiving query; assembling an in-list based on the build expression; and evaluating the value list based on the in-list.

Example 5: The computer-implemented method of any of Examples 1-4, wherein the first operator is a TableScan Semi Join operator.

Example 6: The computer-implemented method of any of Examples 1-5, wherein determining whether the value list is empty comprises evaluating an expression associated with one or more tables at run-time.

Example 7: The computer-implemented method of any of Examples 1-6, further comprising pruning the first operator from the query execution plan without evaluating the one or more predicates of the predicate tree.

Example 8: The computer-implemented method of any of Examples 1-7, further comprising pruning a second operator from the query execution plan responsive to determining that the value list is empty.

Example 9: The computer-implemented method of any of Examples 1-8, wherein the one or more predicates are combined with the value list using a conjunction.

Example 10: The computer-implemented method of any of Examples 1-9, further comprising generating multiple pipelines for execution of the query.

Example 11: The computer-implemented method of any of Examples 1-10, wherein a first pipeline is a build pipeline and wherein a second pipeline is a probe pipeline.

Example 12: The computer-implemented method of any of Examples 1-11, further comprising expanding the predicate tree into the one or more predicates and the value list in the probe pipeline.

Example 13: A system comprising: at least one processor; and at least one memory storing instructions that, when executed by the at least one processor, cause operations comprising: generating a query execution plan for a received query; detecting a first operator with a predicate tree in the query execution plan; responsive to determining that a pruning condition is satisfied, pruning the first operator from the query execution plan; and executing a pruned version of the query execution plan that does not include the first operator.

Example 14: The system of Example 13, wherein the operations further comprise expanding the predicate tree into one or more predicates and a value list, wherein the value list being empty satisfies the pruning condition.

Example 15: The system of any of Examples 13-14, wherein the value list comprises a list of values specified by an expression associated with a first table and a column index of a second table.

Example 16: The system of any of Examples 13-15, wherein the operations further comprise: receiving a request to execute a query; collecting a build expression associated with the receiving query; assembling an in-list based on the build expression; and evaluating the value list based on the in-list.

Example 17: The system of any of Examples 13-16, wherein the first operator is a TableScan Semi Join operator.

Example 18: The system of any of Examples 13-17, wherein determining whether the value list is empty comprises evaluating an expression associated with one or more tables at run-time.

Example 19: The system of any of Examples 13-18, wherein the operations further comprise pruning the first operator from the query execution plan without evaluating the one or more predicates of the predicate tree.

Example 20: A non-transitory computer readable medium storing instructions, which when executed by at least one data processor, result in operations comprising: generating a query execution plan for a received query; detecting a first operator with a predicate tree in the query execution plan; responsive to determining that a pruning condition is satisfied, pruning the first operator from the query execution plan; and executing a pruned version of the query execution plan that does not include the first operator.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer-implemented method comprising:
generating a query execution plan for a received query;
detecting a TableScan Semi Join operator with a predicate tree in the query execution plan;
expanding the predicate tree to include 1) one or more predicates and 2) a value list, both of which are combined using an AND conjunction, such that when the value list is empty, it is determined, without evaluating the one or more predicates, that the TableScan Semi Join operator does not produce a result;
responsive to determining that the value list is empty, pruning the TableScan Semi Join operator from the query execution plan; and
executing a pruned version of the query execution plan that does not include the TableScan Semi Join operator.

2. (canceled)

3. The computer-implemented method of claim 1, wherein the value list comprises a list of values specified by an expression associated with a first table and a column index of a second table.

4. The computer-implemented method of claim 1, further comprising:
receiving a request to execute a query;
collecting a build expression associated with the receiving query;
assembling an in-list based on the build expression; and
evaluating the value list based on the in-list.

5. (canceled)

6. The computer-implemented method of claim 1, wherein determining whether the value list is empty comprises evaluating an expression associated with one or more tables at run-time.

7. The computer-implemented method of claim 1, further comprising pruning the TableScan Semi Join operator from the query execution plan without evaluating the one or more predicates of the predicate tree.

8. The computer-implemented method of claim 1, further comprising pruning a second operator from the query execution plan when it is determined that the TableScan Semi Join operator does not produce a result.

9. (canceled)

10. The computer-implemented method of claim 1, further comprising generating multiple pipelines for execution of the query.

11. The computer-implemented method of claim 10, wherein a first pipeline is a build pipeline and wherein a second pipeline is a probe pipeline.

12. The computer-implemented method of claim 11, further comprising expanding the predicate tree into the one or more predicates and the value list in the probe pipeline.

13. A system comprising:
at least one processor; and
at least one memory storing instructions that, when executed by the at least one processor, cause operations comprising:
generating a query execution plan for a received query;
detecting a TableScan Semi Join operator with a predicate tree in the query execution plan;
expanding the predicate tree to include 1) one or more predicates and 2) a value list, both of which are combined using an AND conjunction, such that when the value list is empty, it is determined, without evaluating the one or more predicates, that the TableScan Semi Join operator does not produce a result;
responsive to determining that the value list is empty, pruning the TableScan Semi Join operator from the query execution plan; and
executing a pruned version of the query execution plan that does not include the TableScan Semi Join operator.

14. (canceled)

15. The system of claim 13, wherein the value list comprises a list of values specified by an expression associated with a first table and a column index of a second table.

16. The system of claim 13, wherein the operations further comprise:
receiving a request to execute a query;
collecting a build expression associated with the receiving query;
assembling an in-list based on the build expression; and
evaluating the value list based on the in-list.

17. (canceled)

18. The system of claim 13, wherein determining whether the value list is empty comprises evaluating an expression associated with one or more tables at run-time.

19. The system of claim 13, wherein the operations further comprise pruning the TableScan Semi Join operator from the query execution plan without evaluating the one or more predicates of the predicate tree.

20. A non-transitory computer readable medium storing instructions, which when executed by at least one data processor, result in operations comprising:
generating a query execution plan for a received query;
detecting a TableScan Semi Join operator with a predicate tree in the query execution plan;
expanding the predicate tree to include 1) one or more predicates and 2) a value list, both of which are combined using an AND conjunction, such that when the value list is empty, it is determined, without evaluating the one or more predicates, that the TableScan Semi Join operator does not produce a result;
responsive to determining that the value list is empty, pruning the TableScan Semi Join operator from the query execution plan; and
executing a pruned version of the query execution plan that does not include the TableScan Semi Join operator.
